(19) United States
(12) Patent Application Publication
(10) Pub. No.: US 2006/0271349 A1
(43) Pub. Date: Nov. 30, 2006

(54) Seamless translation system

(76) Inventor: Philip Scanlan, Las Vegas, NV (US)

Correspondence Address: ROBERT RYAN MORISHITA;MORISHITA LAW FIRM, LLC, 3800 HOWARD HUGHES PKWY,, SUITE 850, LAS VEGAS, NV, 89169, US

(21) Appl. No.: 10/560,876

(22) PCT Filed: Mar. 5, 2002
(86) PCT No.: PCT/AU02/00249

§ 371 Date: May 15, 2006

(30) Foreign Application Priority Data
Mar. 6, 2001 (AU) PR 3607

(51) Int. Cl. G06F 17/28

(52) U.S. Cl. 704/2

(57) ABSTRACT

A method and system for providing automatic translation of an electronic communication from a source language to one or more target languages. A source language is determined using a translation identifier or a language identifier means. A user profile is read to determine the target language. The target language and the source language are compared to determine a required translation.

This invention relates generally to the field of translation, and more particularly to a method and apparatus for providing seamless translation of a communication in a network environment.

### BACKGROUND OF THE INVENTION

Machine translation of communication from one language to another is breaking down the communication barrier between individuals and businesses. Over the past twenty years there have been steady improvements in the quality of machine translation. Various techniques have been developed that translate by phrase rather than word by word. Other techniques use dictionaries or translation memories to translate whole sentences. As a result the grammar of translated communications has improved and hence the readability. Some of the best translation programs are approaching the quality of human translation for common languages and for specific purposes.

Although the technical ability of machine translation software has improved dramatically, the usability has improved very little. In order to translate a document, email or other communication, it is generally necessary to access a translation site and run a translation program. Parameters for the program, such as source and destination language, preferred dictionary, special words, etc, must be input by the user.

In our co-pending U.S. patent application Ser. No. 09/676,690 we describe a one-click translation system that avoids much of the user input that has been necessary to obtain a translation of a communication. The one-click translation system comprises a one-click translation component and a translation manager that combine to provide an almost seamless translation once a user clicks the one-click component.

Although the one-click system is a significant advance over the prior art, it still requires some action by the receiver of the communication. For machine translation of communications to be universally accepted, it must be completely seamless. A system is required that automatically delivers a communication in the preferred language of the recipient.

Some recent technologies approach, but fail to achieve this ideal. For example, U.S. Pat. No. 6,161,082 assigned to AT&T Corp describes a network based language translation system that aims to improve machine translation by utilising the processing power of a network to perform the translation rather than a local machine. However, this patent fails at clarifying how the detection of the involved languages is done. It only mentions that the source and target language can be detected from the communication between the two parties without indicating how this is achieved.

U.S. Pat. No. 5,548,508, assigned to Fujitsu Limited, aims to improve the quality of a machine translation by embedding tags within a document that include contextual information. For example, a <TITLE> ... </TITLE> tag indicates that the words are the title and should be displayed accordingly, a <MODIFY> ... </MODIFY> tag may be used to define the correct order of translated words. The Fujitsu invention achieves the aim of providing a machine translation with high accuracy but does so at the cost of significant pre and post processing that slows the translation. Using the Fujitsu approach it is not possible to provide machine translations in a seamless manner.

Recently granted U.S. Pat. No. 6,073,143, assigned to Sanyo Electric Co. Ltd describes a process to enhance the translation of HTML documents by adding a translation command to each hyperlink in the document. The invention seeks to address the problem of lost hyperlinks that occur during translation. It does not address improved translation of the actual document and does not provide a solution to the problem of delivering a translation seamlessly.

### DISCLOSURE OF THE INVENTION

In one form, although it need not be the only or indeed the broadest form, the invention resides in a method of automatic translation of a communication from a source language to at least one target language including the steps of: determining the source language of a communication by reading a translation identifier or parsing said communication with a language identifier means; determining the target language for the communication by reading a user profile of a user receiving the communication; comparing the target language and source language to determine what translation is required; obtaining a translation; and displaying the translated communication to the user.

The translation identifier may be a language identifier such as an HTML tag in an HTML document or it may be a translation information segment as described in our co-pending application titled Translation Information Segment, the content of which is incorporated herein by reference.

If there is no translation identifier the communication is parsed with language identifier software to determine the source language of the communication. Alternatively, the language identifier means may require human intervention to identify the source language.

The step of determining the target language may include reading a cookie or file on a receiving machine, or obtaining the preference from a single sign-on system, such as Microsoft Passport® or other information repository.

In a further form, the invention resides in a seamless translation system comprising:

an originating computer sending a communication;

a receiving computer receiving a translated communication;

a network connecting the originating computer to the receiving computer; and

a translation manager performing the steps of:

determining the language of the communication;

determining the preferred language of a user of the receiving computer;

obtaining a translation from the language of the communication to the language of the user; and

sending the translated communication to the user.

In another aspect of the invention there is provided a seamless translation system comprising:

an originating computer sending an electronic communication;

a receiving computer receiving a translated electronic communication;

a network connecting the originating computer to the receiving computer;

means for determining the language of the electronic communication;

means for determining the preferred language of a user of the receiving computer;

means for obtaining a translation from the language of the communication to the language of the user; and

means for sending the translated electronic communication to the user.

In yet another aspect of the invention there is provided a seamless translation system comprising:

an electronic communication originating from a source and in a source language containing a translation identifier;

a user profile; and

a translation manager including means for determining the source language and a target language of said electronic communication;

wherein the translation manager executes a required translation of said source language to said target language using the translation identifier and the user profile.

### BRIEF DESCRIPTION OF THE DRAWINGS

To assist in understanding the invention, preferred embodiments will be described with reference to the following figures in which:

FIG. 1 shows a flow chart of a seamless translation process;

FIG. 2 shows a flow chart of the process of determining the source language in a seamless translation process;

FIG. 3 shows a flow chart of the process of determining the target language in a seamless translation process;

FIG. 4 shows a flow chart of the process of obtaining a translation in a seamless translation process; and

FIG. 5 shows a schematic of a seamless translation system.

### DETAILED DESCRIPTION OF THE DRAWINGS

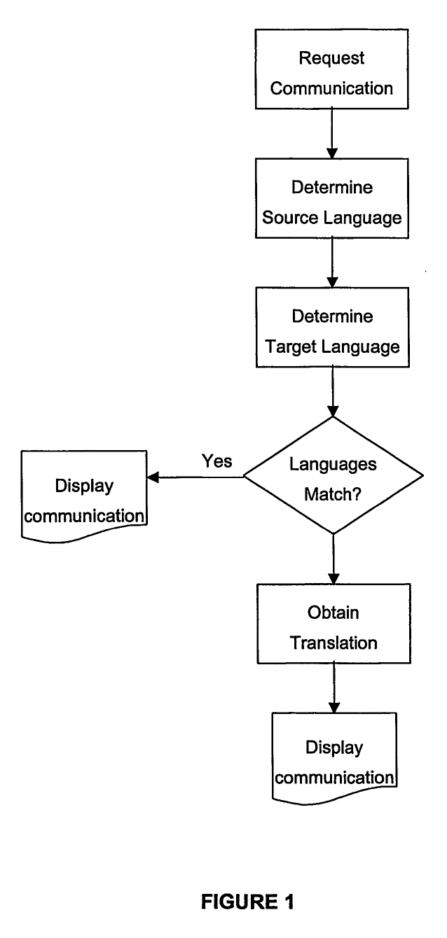

Referring to FIG. 1, there is shown a flowchart of the method of translating a communication from a first language to a second language. For ease of description the method is described in respect of a single translation of a communication, such as a web page, from a source language to a target language. It will be appreciated that it is trivial to extend the process to translate multiple communications to multiple languages or to translate different languages within a single communication. Furthermore, any communication can be translated according to the method including text documents, email, SMS messages, and audio files, video, etc.

In FIG. 1, the method commences when a user requests a communication however the process is the same if the user is sent a communication, such as an email or an attached file. The user may also request communications using other protocols such as FTP. In the example of FIG. 1 the user requests a web page.

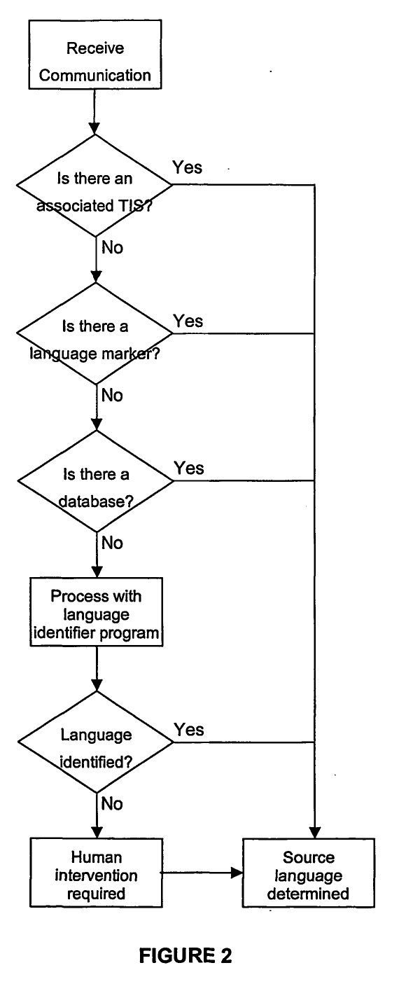

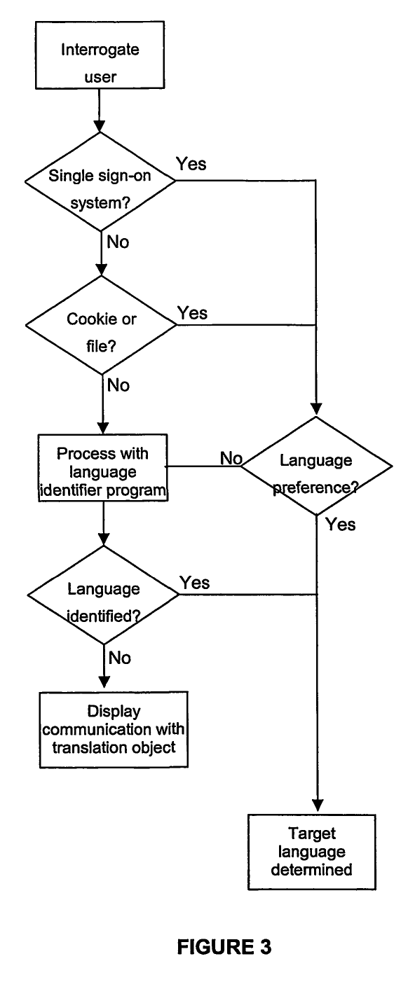

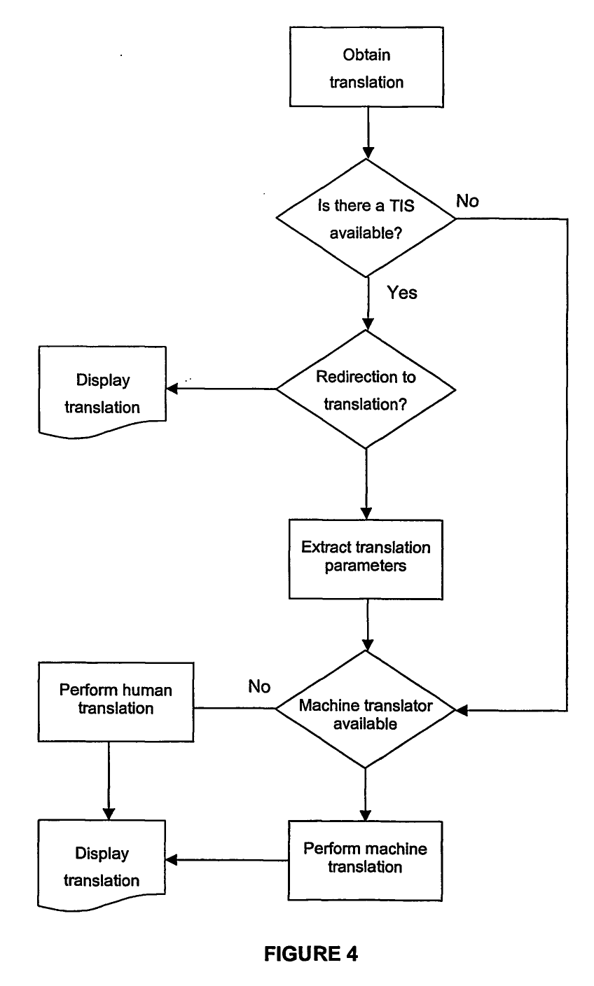

The source language of the communication is determined according to the process expanded in FIG. 2. Once the source language is determined the target language is determined according to the process depicted in FIG. 3. If the source and target language match there is no further processing required and the communication is displayed to the user. If the languages do not match, a translation is obtained according to the process of FIG. 4. The translated communication is displayed to the user in a seamless manner. All of the processing has occurred automatically without the requirement of any action by the receiver of the communication or the sender of the communication. It will be appreciated that the seamless translation system facilitates the breakdown of communication barriers caused by different languages.

Referring now to FIG. 2, the process of determining the source language is shown in greater detail. In the case of a web page, the users browser parses the web page to identify a translation information segment, as described in our co-pending application titled “Translation Information Segment”, in which case all the relevant information for effecting a translation is immediately available. For email this step may be performed by the mail application. Other forms of communication may require a purpose specific software application or plug-in.

If a translation information segment is not identified, the source language may be identified from an HTML language marker. If neither of these local sources are present the language of the communication may be retrieved from an information repository, such as a database or file. If no direct indication of the communication language is available the communication is parsed through a language identification system, such as described in U.S. Pat. No. 5,062,143 assigned to Harris Corporation.

If none of the automatic language identification options are successful the communication may be directed to a human translator for manual identification. Alternatively, the seamless translation process is terminated and the untranslated communication is displayed to the user.

The steps for determining the target language, that is the preferred language of the recipient, are shown in FIG. 3. The recipients computer is interrogated for language preference information. If the user has accessed the communication using a single sign-on system, such as Microsoft Passport® that stores the users language preference (see www.pasport.com), the users language information is readily available. If this is not the case a search is made for a cookie or other file that contains the required information. This information may have been stored during a previous session requiring seamless translation. One readily available source of preferred language is the registry file of the Windows® operating system.

If the target language cannot be determined from any of these sources a language identification program may be employed to analyze the recipients use of the web or other software or files or documents used by the user or resident on their computer to deduce their preferred language.

If all of these optional steps fail to determine the preferred target language the seamless translation process terminates and the communication is displayed in the original language. In this case the communication may be displayed with a translation object in the manner described in our co-pending U.S. application Ser. No. 09/394,968 titled Communication Processing System.

Once the source and target languages have been determined the translation is obtained according to the process shown in FIG. 4. If a translation information segment was detected in the source language identification step it is analyzed for any redirection to available translated communications. For instance, many web sites are available at mirror sites in other languages. The TIS may include a number of redirections to these mirror sites. The appropriate mirror site is determined by the source and target languages determined in the previous steps. For other forms of communication the redirection may be to a file or document stored on a server accessible from the Internet. This situation would apply if a translation had been made previously and cached.

If there is no redirection in the TIS the TIS is analyzed to extract translation parameters such as tone, dictionaries, grammar, and other parameters described in the co-pending application mentioned earlier. These parameters are then passed to a machine translator to perform the translation with the benefit of the parameters obtained from the TIS.

If no suitable machine translator is available a human translator is used to make the translation. A human translator will also be used if the TIS directs a human translation rather than a machine translation. Finally, the translated communication is displayed to the recipient.

The system described above does not account for payment for the translation. There is a cost associated with obtaining translations whether by human or machine. The payment methods available include the recipient paying a subscription fee for all the communications they receive to be seamlessly translated. Alternatively, the originator of communications may pay the subscription fee so that all their communications are seamlessly translated before presentation to a potential customer. This business model is attractive to web-based businesses because their potential customers need never be aware that the site they are visiting is not in their native language.

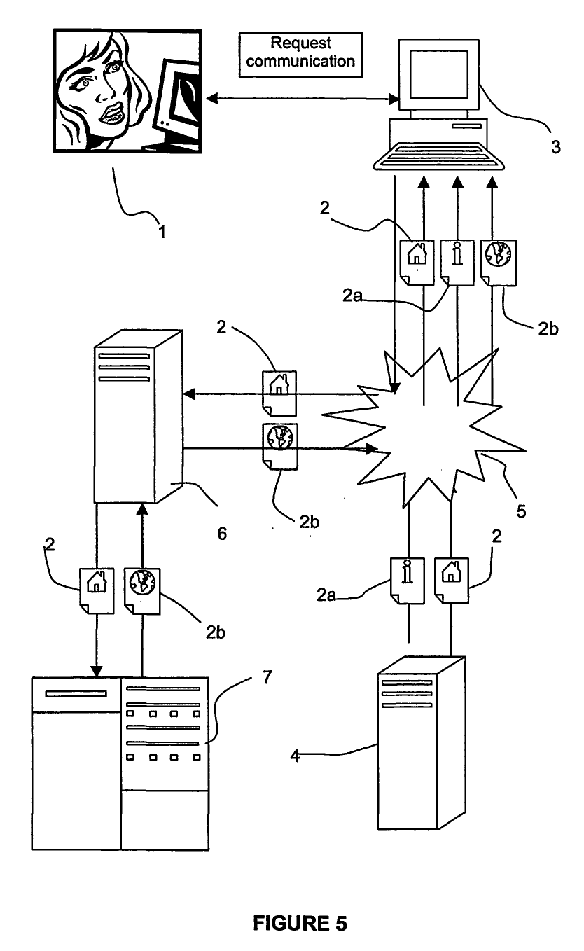

A schematic of a practical implementation of the seamless translation system in a network environment is shown in FIG. 5. A user 1 requests or receives a communication, such as a web page 2, using a browser on a personal computer 3. The browser requests the page 2 from a web server 4 via the Internet 5.

In the example, a plug-in for the browser on the personal computer effects the seamless translation system. The plug-in parses the communication to identify the source language and reads the target language from the registry file of the Windows® operating system. For this example it is assumed that the plug-in locates a translation information segment, and therefore has all the parameters necessary to effect a good translation. The plug-in requests a translation via the Internet 5 using the parameters obtained from the Translation Information Segment.

If the web server 4 has a suitable translation 2a of the communication 2 it is supplied directly to the user 1. If a suitable translation is not available the translation request is passed to a translation manager 6 with the parameters from the TIS. The translation manager 6 obtains the translation 2b from a translation engine 7.

For ease of explanation the translation manager 6 and translation engine 7 have been shown separately. These functions may be embodied in a single application or separate applications running on a single computer. The translation functions may even be performed locally on the personal computer 3 if appropriate software is installed.

Throughout the specification the aim has been to describe embodiments of the invention without limiting the invention to any specific combination of alternate features.

1. A method of automatic translation of an electronic communication from a source language to one or more target languages including the steps of:
determining the source language of the electronic communication by identifying a translation identifier or parsing said electronic communication with a language identifier means;
determining the target language for the electronic communication by reading a user profile of a user receiving the electronic communication;
comparing the target language and source language to determine a required translation;
obtaining the required translation; and
displaying the translated electronic communication to the user.

2. A method of automatic translation of an electronic communication according to claim 1 wherein, the translation identifier is a language identifier such as an HTML tag in an HTML document.

3. A method of automatic translation of an electronic communication according to claim 1 wherein, the translation identifier is a translation information segment.

4. A method of automatic translation of an electronic communication according to claim 1, wherein, if there is no translation identifier in said electronic communication, the method comprises the further step of:
parsing the communication with a language identifier software to determine the source language of the communication; or obtaining human intervention to identify the source language.

5. A method of automatic translation of an electronic communication according to claim 1 wherein the step of determining the target language further includes the step of:
reading a cookie or a file on a receiving machine to obtain the user profile or obtaining a preference language from a single sign-on system, such as Microsoft Passport® or other information repository.

6. A seamless translation system comprising:
an originating computer sending an electronic communication;
a receiving computer receiving a translated electronic communication;
a network connecting the originating computer to the receiving computer; and
a translation manager performing the steps of:
determining the language of the electronic communication;
determining the preferred language of a user of the receiving computer;
obtaining a translation from the language of the communication to the language of the user; and
sending the translated communication to the user.

7. A seamless translation system comprising:
an electronic communication originating from a source and in a source language containing a translation identifier;
a user profile; and
a translation manager including means for determining the source language and a target language of said electronic communication;
wherein the translation manager executes a required translation of said source language to said target language using the translation identifier and the user profile.

8. A seamless translation system comprising:
an originating computer sending an electronic communication;
a receiving computer receiving a translated electronic communication;
a network connecting the originating computer to the receiving computer;
means for determining the language of the electronic communication;
means for determining the preferred language of a user of the receiving computer;
means for obtaining a translation from the language of the communication to the language of the user; and
means for sending the translated electronic communication to the user.

9. A seamless translation system according to claim 8 further comprising a translation manager, said translation manager including:
said means for determining the language of the electronic communication;
said means for determining the preferred language of a user of the receiving computer;
said means for obtaining a translation from the language of the communication to the language of the user; and
said means for sending the translated electronic communication to the user.
